(19) United States
(12) Patent Application Publication
(10) Pub. No.: US 2026/0357874 A1
(43) Pub. Date: Nov. 12, 2026

(54) GEARED MOTOR WITH GEARBOX WHICH HAS AT LEAST ONE FIRST PLANETARY GEAR STAGE

(71) Applicant: SEW-EURODRIVE GMBH & CO. KG, Bruchsal (DE)

(72) Inventors: Uwe HÄCKER, Weingarten (DE); Martin LÖFFEL, Pfinztal (DE); Peter LORENZ, Steinbach / Taunus (DE); Florian MÖRZ, Bruchsal (DE)

(73) Assignee: SEW-EURODRIVE GMBH & CO. KG, Bruchsal (DE)

(21) Appl. No.: 19/470,321

(22) PCT Filed: Feb. 21, 2024
(86) PCT No.: PCT/EP2024/054445

§ 371 Date: Sep. 29, 2025

(30) Foreign Application Priority Data
Mar. 27, 2023 (DE) 102023001201.7

(51) Int. Cl. F16H 1/32; F16H 1/46; F16H 55/08

(52) U.S. Cl. CPC F16H 1/32; F16H 1/46; F16H 55/08

(57) ABSTRACT

A geared motor includes a gearbox, which has at least one first planetary gear stage. The first planetary gear stage has at least one first planet gear in engagement with the inner toothing of a first ring gear and with the running toothing of a first sun gear. The first sun gear has a spline which is spaced apart from the running toothing, and the spline has a face-width crowning.

### FIELD OF THE INVENTION

The present invention relates to a geared motor with gearbox which has at least one first planetary gear stage.

### BACKGROUND INFORMATION

In certain conventional systems, a sun gear of a planetary gear stage has a running toothing which is in engagement with planet gears that are in engagement with the inner toothing of a ring gear.

A gearbox is described in Japanese Patent Document No. 2007-146884.

A drive device is described in German Patent Document No. 10 2021 115 043.

A series of shafts is described in German Patent Document No. 103 16 155.

A gear for a rolling mill drive is described in German Patent Document No. 10 2021 206 054.

An axle gear assembly with swiveling gear set is described in German Patent Document No. 10 2019 216 427.

A geared motor is described in German Patent Document No. 10 2004 012 022.

### SUMMARY

Example embodiments of the present invention provide a geared motor with an extended service life.

According to example embodiments, a geared motor has a gearbox which has at least one first planetary gear stage. The first planetary gear stage has at least one first planet gear which is in engagement with the inner toothing of a first ring gear and with the running toothing of a first sun gear. The first sun gear has a spline spaced from the running toothing, and the spline has a face-width crowning.

An advantage is that the crowning compensates for misalignment and thus provides for a more uniform load distribution among the planet gears. The service life and/or operating life of the gearbox is thus improved.

Although the face-width crowning reduces the contact surface between the inner toothing of the adapter shaft and the spline, misalignments or alignment errors can be compensated for via the face-width crowning.

For example, the first sun gear has a cylindrical region between the running toothing and the spline, which is spaced from the running toothing and adjoins a hyperbolic region, which, at its end facing away from the cylindrical region, adjoins a conical region which overlaps the spline and radially limits the spline, e.g., so that the toothing is conically beveled. For example, the cone angle, e.g., the half-opening angle of the straight taper or cone, of the conical region is between 20° and 40°.

An advantage is that, unlike an elliptical or parabolic region, the hyperbolic region provides improved rigidity and an improved transition between the cylindrical and conical regions, e.g., with a lower probability of failure.

The cone angle mentioned above allows for a long transition between the spline and the cylindrical region, thus ensuring high load-bearing capacity. In addition, the increased mass and/or moment of inertia improves synchronization, because rotational speed fluctuations of the first sun gear are dampened more effectively.

According to example embodiments, the spline has a profile crowning, e. g., a tooth profile crowning and/or a barrel crowning. An advantage is that it allows for further improved compensation of misalignments.

According to example embodiments, the face-width crowning is more than 100 μm. An advantage is that large misalignments can be compensated for via the spline of the backlash-free splined shaft connection.

According to example embodiments, the face-width crowning is between 100 μm and 300 μm. An advantage is that large misalignments can be compensated for via the spline of the backlash-free splined shaft connection.

According to example embodiments, the axial width of the first sun gear or the axial width of the spline is between 10 and 100 millimeters. An advantage is that large misalignments can be compensated for via a backlash-free splined shaft connection including a spline.

According to example embodiments, the spline is arranged as an involute toothing. An advantage is that ready production is possible.

According to example embodiments, the standard pressure angle of the spline, e. g., the involute toothing, is between 25° and 40°. An advantage is that the tooth height of the spline is low and thus the service life can be improved.

According to example embodiments, the standard pressure angle of the spline, e.g., the involute toothing, is 30°. An advantage is that the gearbox can be arranged to be as compact as possible because the spline can be provided with a very low tooth height. An inexpensive tool can also be used to produce the spline.

According to example embodiments, the tooth thickness of each tooth of the spline of the first sun gear has a sinusoidal curve as a function of the axial position, e.g., not a parabolic curve. For example, the maximum tooth thickness of each tooth of the spline is arranged axially in the center of the spline. The axial direction is oriented parallel to the axis of rotation of the first sun gear. An advantage is that a further improved load distribution between the planet gears can be achieved and thus also an improved service life.

According to example embodiments, the first sun gear is tapered between the running toothing and the spline. An advantage is that a predetermined breaking point can be integrated in the first sun gear. Overloading of the gearbox can thus be avoided.

According to example embodiments, the first sun gear has a region between the running toothing and the spline, the smallest outer diameter of which region is smaller than: the smallest outer diameter of the running toothing; the root diameter of the running toothing; the root diameter of the spline; and/or the smallest outer diameter of the spline. An advantage is that in the event of an overload, the region arranged between the spline n of the running toothing of the first sun gear fails first and thus is arranged as a predetermined breaking point.

According to example embodiments In an, the largest outer diameter of the running toothing and/or the tip diameter of the running toothing is smaller than the largest outer diameter of the spline and/or smaller than the tip diameter of the spline. An advantage is that a compact configuration is possible. For example, only such a small amount of torque can be transmitted from the motor to the gearbox that the first sun gear does not yet fail.

According to example embodiments, the spline of the first sun gear is plugged into the inner toothing of an adapter shaft, which is connected for conjoint rotation with the rotor shaft of the electric motor, e. g., via a feather key connection. An advantage is that the spline can be used to compensate for misalignments.

According to example embodiments, the planet gear is rotatably mounted on a planetary carrier which has an internal toothing, e.g., with straight flanks. An advantage is that the crowned spline rolls along straight-flanked teeth of the inner toothing and thus misalignments can be compensated for.

According to example embodiments, the gearbox has a second planetary gear stage, which has a second sun gear, which has a running toothing and a spline axially spaced from the running toothing. The spline of the second sun gear has a face-width crowning, e.g., which is between 100 μm and 300 μm. For example, the axial width of the second sun gear or the axial width of the spline of the second sun gear is between 10 and 100 millimeters. For example, the standard pressure angle of the spline, e.g., the involute toothing, of the second sun gear is 30°. An advantage is that misalignments can be compensated for with a backlash-free splined shaft connection. According to example embodiments, the spline of the second sun gear is plugged into the inner toothing of the first planetary carrier. For example, the first planetary carrier is connected to the second sun gear with no or at least little backlash. An advantage is that misalignments can be compensated for via the spline.

According to example embodiments, the gearbox has a third planetary gear stage, which has a third sun gear with a running toothing and a spline axially spaced from the running toothing. The spline of the third sun gear has a face-width crowning, e.g., which is between 100 μm and 300 μm. For example, the axial width of the third sun gear or the axial width of the spline of the third sun gear is between 10 and 100 millimeters. For example, the standard pressure angle of the spline, e.g., the involute toothing, of the third sun gear is 30°. An advantage is that the tooth height of the spline can be kept low and thus the gearbox can be compact.

According to example embodiments, the spline of the third sun gear is plugged into the inner toothing of the second planetary carrier. For example, the second planetary carrier is connected to the third sun gear in the circumferential direction with no or at least little backlash. The third planetary gear stage of the gearbox has at least one third planet gear which is in engagement with the inner toothing of a third ring gear and with the running toothing of a third sun gear.

Further features and aspects of example embodiments of the present invention are explained in more detail below with reference to the appended schematic Figures.

### BRIEF DESCRIPTION OF THE DRAWINGS

FIG. 1 is a cross-sectional view of a geared motor.

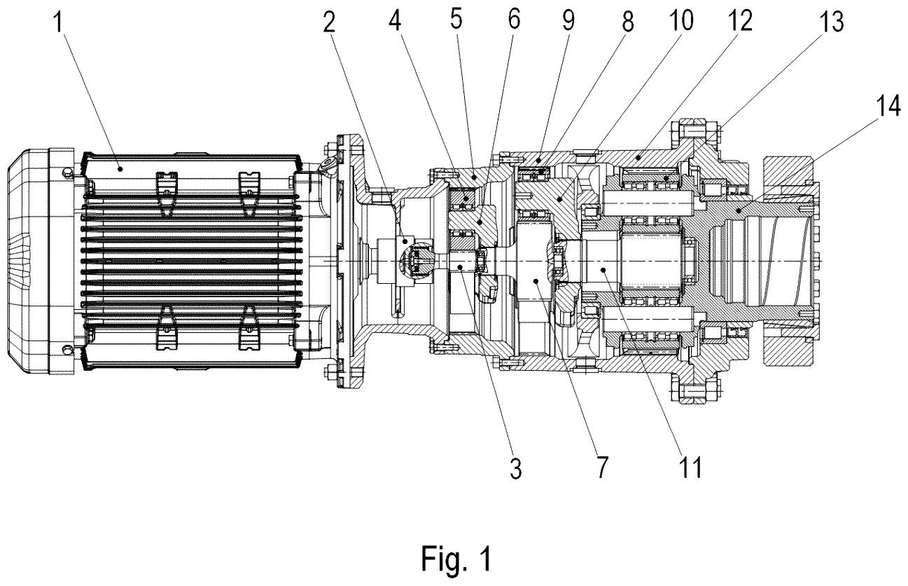

FIG. 2 is an enlarged view of a portion of FIG. 1.

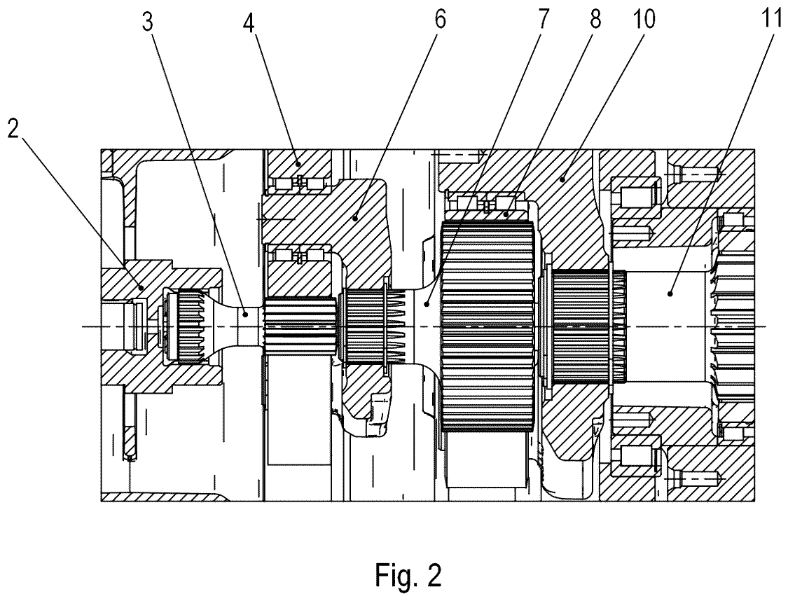

### DETAILED DESCRIPTION

As illustrated in the Figures, the geared motor has an electric motor 1 whose rotor shaft is connected for conjoint rotation to an adapter shaft 2 which drives a gearbox.

The first sun gear 3 has a running toothing and a spline spaced from the running toothing, which is plugged into the adapter shaft 2, e.g., into an inner toothing of the adapter shaft 2.

The spline has a face-width crowning and/or a profile crowning, e.g., a tooth profile crowning and/or a barrel crowning.

The face-width crowning means that misalignments between the adapter shaft 2 and the first sun gear 3 can be compensated for by the splined shaft connection formed by the inner toothing of the adapter shaft 2 and the spline of the first sun gear 3.

For example, a large face-width crowning of 100 to 200 μm is provided, and the axial width of the first sun gear 3 or at least of the spline of the first sun gear 3 is between 10 and 100 millimeters.

The spline is, for example, arranged as involute toothing, e.g., with a standard pressure angle of 30°. With this unusual value of the standard pressure angle, a particularly low tooth height is sufficient in order to transmit the intended torque from the adapter shaft 2 to the first sun gear 3. The installation space can thus be used as efficiently as possible.

In addition, the running toothing is in engagement with first planet gears 6, which also are in engagement with the inner toothing of a first ring gear 5. The planet gears 6 are rotatably mounted in a first planetary carrier 6.

Via the face-width crowning, the load distribution on the first planet gears 6 is homogenized.

The inner toothing of adapter shaft 2 is straight-flanked, i.e., without face-width crowning. For example, this inner toothing is also arranged as an involute toothing.

An optional additional profile crowning further improves the ability to compensate for misalignments. The head height and/or the maximum radial distance of the spline has exactly one maximum as a function of the axial position. The tooth height thus initially increases in the axial direction and then decreases again.

In the circumferential direction, the spline is plugged into the inner toothing of the adapter shaft 2 with no or at least little backlash. Thus, the torque generated by the electric motor can be transmitted to the gearbox with no or at least little backlash.

For example, the gearbox includes multiple stages. For this purpose, the first planetary carrier 6 also has inner toothing into which spline of the second sun gear 7 is plugged, which is axially spaced from a running toothing of the second sun gear 7.

This spline of the second sun gear 7 also has face-width crowning and/or profile crowning, and the inner toothing of the first planetary carrier 6 is straight-flanked, i.e., without face-width crowning and without profile crowning.

The running toothing of the second sun gear 7 is in engagement with second planet gears 8, which are rotatably mounted in a second planetary carrier 10 and are in engagement with the inner toothing of a second ring gear 9.

In the second planetary carrier 10, an inner toothing, e. g., a straight-sided inner toothing, is also provided, into which a spline of a third sun gear 11 is plugged, which spline is axially spaced from a running toothing of the third sun gear, which running toothing is in engagement with third planet gears 13, which in turn are in engagement with the inner toothing of a third ring gear 12.

The spline of the third sun gear 11 is also arranged as an involute toothing and again has a face-width crowning and/or a profile crowning.

The third planet gears 13 are rotatably mounted in a third planetary carrier 14, which is arranged as the output shaft of the gearbox.

The first sun gear 3 is tapered in the region arranged axially between the spline of the first sun gear 3 and the running toothing of the first sun gear 3. Thus, the smallest outer diameter of this region is smaller than the root diameter and/or smallest outer diameter of the running toothing of the first sun gear 3 and is smaller than the root diameter and/or smallest outer diameter of the spline of the first sun gear 3. Via specifying the smallest outside diameter of this region, the gearbox can be protected from overload, because in the event of an overload, the tapered region fails first.

The largest outer diameter of the spline of the first sun gear 3 is larger than the largest outer diameter of the running toothing of the first sun gear 3. Thus, a large torque can be transmitted from the electric motor to the gearbox via the adapter shaft 2.

If the first sun gear 3 fails, it can be replaced with little effort. This is because only the gearbox needs to be detached from the electric motor together with the adapter shaft 2 and then the first sun gear 3 needs to be replaced.

For example, a sinusoidal curve of the face-width crowning results in improved compensation of misalignment and thus an improved service life.

For example, the first sun gear has a cylindrical region 3 between the running toothing and the spline, which is spaced from the running toothing and adjoins a hyperbolic region, which, at its end facing away from the cylindrical region, adjoins a conical region which overlaps the spline and radially limits the spline, e.g., so that the toothing is conically beveled. For example, the cone angle of the conical region is between 20° and 40°.

For example, instead of the three-stage gearbox, the gearbox may be arranged only as a single-stage or two-stage planetary gearbox or as a gearbox with the first planetary gear stage and further gear stages, which are arranged as spur gear stages.

### LIST OF REFERENCE NUMERALS

1 Electric motor
2 Adapter shaft
3 First sun gear
4 First planet gear
5 First ring gear
6 First planetary carrier
7 Second sun gear
8 Second planet gear
9 Second ring gear
10 Second planetary carrier
11 Third sun gear
12 Third ring gear
13 Third planet gear

1 to 16. (canceled)

17. A geared motor, comprising:
a gearbox including a first planetary gear stage, the first planetary gear stage including:
a first ring gear including an inner toothing;
a first sun gear including a running toothing and a spline spaced apart from the running toothing, the spline having a face-width crowning; and
a first planet gear in engagement with the inner toothing of the first ring gear and with the running toothing of the first sun gear, the first sun gear including a spline spaced apart from the running toothing, the spline having a face-width crowning.

18. The geared motor according to claim 17, wherein the first sun gear has a cylindrical region between the running toothing and the spline, spaced from the running toothing, and adjoining a hyperbolic region, at an end facing away from the cylindrical region the hyperbolic region adjoining a conical region that overlaps the spline and radially limits the spline.

19. The geared motor according to claim 18, wherein a toothing of the spline is conically beveled.

20. The geared motor according to claim 18, wherein a cone angle of the conical region is between 20° and 40°.

21. The geared motor according to claim 17, wherein the spline has a profile crowning, a tooth profile crowning, and/or a barrel crowning.

22. The geared motor according to claim 17, wherein the face-width crowning is more than 100 μm.

23. The geared motor according to claim 17, wherein the face-width crowning is between 100 μm and 300 μm.

24. The geared motor according to claim 17,wherein a axial width of the first sun gear or the axial width of the spline is between 10 and 100 millimeters.

25. The geared motor according to claim 17, wherein the spline includes an involute toothing.

26. The geared motor according to claim 17, wherein a pressure angle of the spline is between 25° and 40°.

27. The geared motor according to claim 17, wherein a pressure angle of the spline is 30°.

28. The geared motor according to claim 17, wherein a tooth thickness of each tooth of the spline of the first sun gear has a sinusoidal curve as a function of axial position.

29. The geared motor according to claim 17, wherein a maximum tooth thickness of each tooth of the spline is arranged at an axial center of the spline.

30. The geared motor according to claim 17, wherein the first sun gear is tapered between the running toothing and the spline.

31. The geared motor according to claim 17, wherein the first sun gear has a region between the running toothing and the spline, a smallest outer diameter the region being smaller than: a smallest outer diameter of the running toothing; a root diameter of the running toothing; a root diameter of the spline; and/or a smallest outer diameter of the spline.

32. The geared motor according to claim 17, wherein a largest outer diameter of the running toothing and/or a tip diameter of the running toothing is smaller than a largest outside diameter of the spline and/or is smaller than a tip diameter of the spline.

33. The geared motor according to claim 17, wherein the spline of the first sun gear is arranged in an inner toothing of an adapter shaft connected for conjoint rotation with a rotor shaft of an electric motor.

34. The geared motor according to claim 17, wherein the first planet gear is rotatably mounted on a planetary carrier having an internal toothing.

35. The geared motor according to claim 17, wherein the gearbox includes a second planetary gear stage, the second planetary gear stage including a second sun gear having a running toothing and a spline axially spaced from the running toothing of the second sun gear, the spline of the second sun gear having a face-width crowning.

36. The geared motor according to claim 35, wherein the face-width crowning of the second sun gear is between 100 μm and 300 μm, an axial width of the second sun gear and/or an axial width of the spline of the second sun gear is between 10 and 100 millimeters, and a pressure angle of the spline of the second sun gear is 30°.

37. The geared motor according to claim 35, wherein the spline of the second sun gear is arranged in an inner toothing of a first planetary carrier of the first planetary gear stage.

38. The geared motor according to claim 37, wherein the first planetary carrier is connected to the second sun gear without backlash.

39. The geared motor according to claim 35, wherein the gearbox includes a third planetary gear stage, the third planetary gear stage including a third sun gear having a running toothing and a spline axially spaced from the running toothing of the third sun gear, the spline of the third sun gear having a face-width crowning.

40. The geared motor according to claim 39 wherein the face-width crowning of the third sun gear is between 100 μm and 300 μm, an axial width of the third sun gear and/or an axial width of the spline of the third sun gear is between 10 and 100 millimeters, and a pressure angle of the spline of the third sun gear is 30°.

41. The geared motor according to claim 39, wherein the spline of the third sun gear is arranged in an inner toothing of a second planetary carrier of the second planetary gear stage, the third planetary gear stage including a third planet gear in engagement with an inner toothing of a third ring gear and with a running toothing of a third sun gear.

42. The geared motor according to claim 41, wherein the second planetary carrier is connected to the third sun gear in a circumferential direction without backlash.
